(19) United States
(12) Patent Application Publication
(10) Pub. No.: US 2009/0204621 A1
(43) Pub. Date: Aug. 13, 2009

(54) DATA WEDGE PROFILE SWITCHING

(75) Inventors: James Fagioli, Holtsville, NY (US); Roman Woloszczuk, London (GB); Prashanth Kadur, Holbrook, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/029,266

(22) Filed: Feb. 11, 2008

(51) Int. Cl. G06F 17/30

(52) U.S. Cl. 707/100; 707/E17.005

(57) ABSTRACT

Systems, devices and/or methods that facilitate automatic data wedge configuration profile switching are presented. An automatic data wedge configuration profile switching system can improve productivity and reduce errors associated with manually switching data wedge configuration profiles. The automatic data wedge configuration profile switching system can automatically switch profiles based in part on indications related to foreground applications. This indication can be related to changing from a first foreground application to a second foreground application, can be related to changing from a first information input scheme to a second information input scheme within a foreground application, can be related to messages sent from foreground applications, or combinations thereof.

### TECHNICAL FIELD

The subject innovation relates generally to data wedge devices, systems, and/or methods and more particularly to data wedge devices, systems, and/or methods to facilitate automatic data wedge configuration profile switching.

### BACKGROUND

Traditionally, data wedge systems are employed to facilitate entry of information into foreground software applications running on a computer or computer device. These systems, while effective in placing information in the foreground application, are also tedious and cumbersome when the foreground application changes from a first application to a second application (e.g., switching from a spreadsheet application to an item tracking application) or when the information entry scheme in a first application changes (e.g., different forms or fields within the same foreground application employ different data wedge configurations). In some cases, the user can be required to manually initiate a data wedge configuration change as the foreground application changes or the information entry scheme in a foreground application changes. As a result of using manually changed configurations for data wedge systems, productivity can be reduced, information can be entered in a non-conforming manner, errors in actual information entry can occur, or combinations thereof can result.

Many traditional data wedge systems can be ignorant of the foreground environment and information entry schemes, resulting in data wedge systems that merely place information in an ignorant manner. For example, where a bar code scanner reads bar codes related to medicine administered to a hospital patient, the extracted drug information can be entered into a patient's medical records in a medical record foreground application. However, where the foreground application is changed from a medical record application to, for example, a drug inventory application, the conventional data wedge can be ignorant of this foreground application change and can continue to attempt to enter the extracted drug information (e.g., from the scanned medicine bar code) into the new foreground application. This can lead to serious breaches in data entry where, for example, the extracted drug information entered into the drug inventory application can falsely indicate an increased inventory for a drug already accounted for in the drug inventory system.

In another example, a scanner can generate field information from a scanned form using optical character recognition (OCR), which information can then be entered into a data base form in a foreground application. Where the user, for example, switches to a different form in the same foreground application, the scanned OCR information can be incorrectly entered into the second form in the foreground application because the traditional data wedge is ignorant of the change in foreground application.

A conventional data wedge typically requires the user to interact with the data wedge to facilitate changing foreground applications or information entry schemes in the foreground application. For example, when a user changes from a first to a second foreground application, the user can be required to cause the data wedge to change profiles to a profile appropriate for information entry in the second foreground application. Similarly, where the foreground application information entry scheme changes, for example from a first to a second form in the same foreground application, the user can be required to cause the data wedge to change profiles to a profile appropriate for information entry under the new information entry scheme.

Thus, conventional data wedges that are ignorant of the foreground environment can be problematic for efficient entry of information. Further, conventional data wedge systems can cause an incorrect entry of information, can corrupt information entered, can cause system crashes, or combinations thereof, among many other problems related to mishandling information entry from an information source into a foreground application where the foreground application changes or the information entry scheme in a foreground application changes.

### SUMMARY

The following presents a simplified summary of the subject innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Conventionally, data wedges enter information from a source into a foreground application. Where that foreground application changes to a different application or the information entry scheme changes for the foreground application, traditional data wedges can result in data entry errors and loss of productivity where a user can be required to change the information entry scheme of the traditional data wedge to accommodate the changed foreground application or information entry scheme of the foreground application. In contrast, by employing automatic data wedge configuration profile switching, an improved data wedge system, device and/or method can reduce errors and improve productivity by freeing the user from having to initiate a profile change in the data wedge.

In accordance with one aspect of the disclosed subject matter, an improved data wedge can facilitate automatic switching of data wedge profiles. These profiles can be related to the information entry scheme of the data wedge for a plurality of applications. The configuration profiles can be stored in a configuration profile storage area allowing the data wedge access to a library of application configuration profiles that can be automatically selected from, based in part on an indication related to the foreground application into which information is being entered. For example, a first configuration profile can be for information entry into an item tracking application, a second configuration profile can be for a drug inventory application, a third configuration can be for a patient record application, a fourth configuration profile can be for a scheduling application, and a fifth configuration profile can be for OCR scanned documents, among nearly a limitless number of other configuration profiles.

Based in part on an indication related to the foreground application receiving information from an information source through the data wedge, a data wedge with automatic configuration profile switching can select an appropriate configuration profile to better ensure proper information entry into the foreground application. An indication related to the foreground application can be related to the particular application in the foreground. Thus, as a first foreground application (and appropriate data wedge configuration profile) switches to a second foreground application, the data wedge can automatically select, based on an indication that the second application is the new foreground application, an appropriate configuration profile for populating the second foreground application. For example, where the foreground application changes from a drug inventory application (for which a drug inventory configuration profile allowed information entry) to a patient record application, a data wedge in accordance with an aspect of the disclosed invention can automatically select the patient record configuration profile to allow information from a source to be properly communicated to the patient record application in the foreground. Further, where an appropriate configuration profile cannot be located, a default profile can be employed or a new configuration profile can be created. Additionally, inferences can be made in relation to the information being passed to the foreground application such that a default type configuration profile can approximate an appropriate configuration profile.

In another aspect, an indication relating to a foreground application can indicate that a data wedge configuration profile can be switched to facilitate proper information entry into the foreground application. The indication relating to the foreground application can be a message sent from the foreground application to the data wedge directly or to other systems, devices, or software, among other types of indications. This can, for example, facilitate employing different configuration profiles for the same foreground application. As an example, a patient record application can employ a first form and related data wedge configuration profile to populate a medications record within the patient record foreground application, and automatically employ a second data wedge configuration profile to populate a second form relating to post operative care in the patient medical record foreground application.

To the accomplishment of the foregoing and related ends, the innovation, then, comprises the features hereinafter fully described and particularly pointed out in the claims. The following description and the annexed drawings set forth in detail certain illustrative embodiments of the innovation. These embodiments can be indicative, however, of but a few of the various ways in which the principles of the innovation can be employed. Other objects, advantages, and novel features of the innovation will become apparent from the following detailed description of the innovation when considered in conjunction with the drawings.

### BRIEF DESCRIPTION OF THE DRAWINGS

FIG. 1 is a high level diagram of a system that can facilitate improved data wedge configuration switching in accordance with an aspect of the subject matter disclosed herein.

FIG. 2 is a diagram of a system that can facilitate improved data wedge configuration switching in accordance with an aspect of the subject matter disclosed herein.

FIG. 3 is a diagram of a system that can facilitate improved data wedge configuration switching in accordance with an aspect of the subject matter disclosed herein.

FIG. 4 is a diagram of a system that can facilitate improved data wedge configuration switching in accordance with an aspect of the subject matter disclosed herein.

FIG. 5 is a schematic illustration of a system that can facilitate improved data wedge configuration switching in accordance with an aspect of the subject matter disclosed herein.

FIG. 6 illustrates a methodology that can facilitate improved data wedge configuration switching in accordance with an aspect of the subject matter disclosed herein.

FIG. 7 illustrates a methodology that can facilitate improved data wedge configuration switching in accordance with an aspect of the subject matter disclosed herein.

FIG. 8 illustrates a methodology that can facilitate improved data wedge configuration switching in accordance with an aspect of the subject matter disclosed herein.

FIG. 9 a methodology that can facilitate improved data wedge configuration switching in accordance with an aspect of the subject matter disclosed herein.

FIG. 10 illustrates a block diagram of an exemplary electronic device that can facilitate improved data wedge configuration switching in accordance with an aspect of the subject matter disclosed herein.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It is evident, however, that the disclosed subject matter can be practiced without these specific details. In other instances, well-known structures and devices are shown in block diagram form in order to facilitate describing the subject innovation.

Traditional data wedge systems generally are ignorant of the foreground application and can require the user to initiate a change in the data wedge configuration profile to facilitate appropriate entry of information into changing foreground applications or within changing information entry schema in the same foreground application. For example, an item tracking application can have a plurality of forms within the application. A conventional data wedge can require the item tracking application user to initiate a data wedge configuration profile change for each form change occurring while the user is entering information into the item tracking application. Thus, as a user switches from, for example, an “item received” form, to an “item stored” form, to an “item sent” form, the user may have to initiate two or more data wedge configuration changes. In this example, this can require additional training of the user to learn how to switch data wedge configuration profiles, can subject data entry to user errors where the user improperly selects an inappropriate data wedge configuration profile, or can result in lost productivity where the user takes time to switch data wedge configuration profiles manually. In contrast automatically switching data wedge profiles can facilitate improved productivity and reduced error rates.

In one aspect, a data wedge profile switching system can automatically switch data wedge configuration profiles based in part on an indication related to the foreground application to facilitate improved productivity and reduced error rates in accordance with an aspect of the subject matter disclosed herein. The indication can be related to the foreground application changes (e.g., switching from a first foreground application to a second foreground application) such that, based at least in part on the indication, the data wedge can automatically change the data wedge configuration profile. For example, where a first data wedge configuration profile is being used with a spreadsheet foreground application, where the foreground application changes to an item tracking application, the data wedge can receive an indication of the change in foreground applications and automatically change the data wedge configuration profile to an item tracking data wedge configuration profile.

In another aspect, a library of data wedge configuration profiles can be stored in a configuration profile store. This can facilitate a data wedge having access to a plurality of configuration profiles that are appropriate to foreground applications that can be encountered. The configuration profile store can be a local or distributed store. For example, an information technology (IT) manager can produce a selection of data wedge configuration profiles related to different versions of software available to employees of the company. These configuration profiles can be stored in the configuration profile store such that as the employee switches between corporate software packages, the data wedge can access the configuration profiles provided by the IT manager in the configuration profile store. Accessing configuration profiles specific to software versions and packages deployed across the company can facilitate automatically selecting the most appropriate data wedge configuration based on the software running in the foreground. For example, where the foreground application in location one switches to version A of a spreadsheet application, a data wedge configuration profile for version A can be selected from the configuration profile store, while in a second location where the foreground application is switched to version D of the spreadsheet application, a data wedge in the second location can select a data wedge configuration profile for version D from the configuration profile store.

In another aspect, data wedge configuration profiles can be specifically predetermined to be appropriate configuration profiles for specific foreground applications. This can facilitate direct mapping of selected data wedge configuration profiles to applications as they become foreground applications, for example, on a user workstation. For example, when the data wedge system is set up, an inventory application can have an inventory configuration profile associated with the inventory application, a parts lookup application can have a parts lookup configuration profile associated with the parts lookup application, and a price checking application can have a price checking configuration profile associated with the price checking application. Thus, as the data wedge receives an indication related to the foreground application, for example indicating that the price checking application has become the foreground application, the associated configuration profile can be applied to the data wedge directly. Thus, these precise associations can facilitate automatically changing data wedge configuration profiles. Additionally, as discussed herein, other determinations and inferences can be made relating to automatically changing a data wedge configuration profile based at least in part on the indication relating to the foreground application.

In another aspect, where a matching configuration profile cannot be located in the configuration profile store, a default data wedge configuration can be selected. Further, where close matches are available, inferences or determinations can be made to select a near match configuration profile. For example, where a spreadsheet application has a version A and a version B of the application, the data wedge can select the configuration profile for version A to populate a version B foreground application (e.g., where a configuration profile for version B is unavailable). Similarly, for example, the data wedge can select a default configuration where a configuration for version A would be inappropriate for populating a version B spreadsheet foreground application (e.g., where a configuration profile for version B is unavailable). Further, where a configuration profile is unavailable, an appropriate configuration profile can be defined rather than switching to a default or near match configuration profile.

In another aspect, an indication relating to a foreground application can facilitate automatic switching of a data wedge configuration profile for the same foreground application. The indication can be related to, for example, a change in the information population scheme of the foreground application. This can occur where an application has a plurality of screens, forms, profiles, fields, or the like. For example, where a spreadsheet foreground application has a plurality of pages, a different data wedge profile can be appropriate for different pages within the same spreadsheet foreground application. Thus, as the user switches between pages in the spreadsheet, the data wedge can automatically switch the data wedge configuration profile. The configuration profiles can again be stored in a local or distributed manner in a configuration profile store. Additionally, precise associations can be employed, as herein discussed, to associate specific configuration profiles with specific information entry schema. Also, where an appropriate configuration profile is unavailable, a default configuration profile or a near match configuration profile can be employed based on inferences or determinations related to the indication relating to the foreground application. Additionally, where a configuration profile is unavailable, an appropriate configuration profile can be defined rather than switching to a default or near match configuration profile.

The subject innovation is hereinafter illustrated with respect to one or more arbitrary architectures for performing the disclosed subject matter. However, it will be appreciated by one of skill in the art that one or more aspects of the subject innovation can be employed in other data wedge system architectures and is not limited to the examples herein presented.

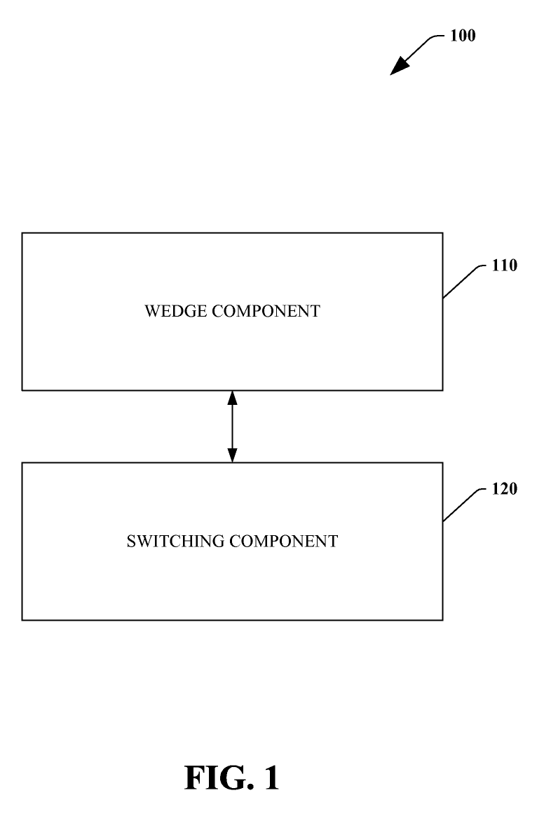

Turning to FIG. 1, illustrated is a system 100 that can facilitate improved data wedge configuration switching in accordance with an aspect of the disclosed subject matter. System 100 can include a wedge component 110 communicatively coupled to a switching component 120. The switching component 120 can be a separate component from the wedge component 110 (e.g., local or distributed) or can be a subcomponent of the wedge component 110. The wedge component 110 can facilitate passing information from a source component to a foreground application. A source component can include any device, system, or method that presents information for a foreground application or system. For example, a source component can be a bar code scanner and data base that provides information relating to a scanned bar code to a foreground application, such as, a grocery checkout system, an item tracking system, or a library book checkout application, among a nearly limitless number of other applications and systems. The switching component 120 can facilitate automatically switching the data wedge configuration profile to an appropriate configuration profile based at least in part on an indication related to the foreground application.

As an example, when a library employee switches from a book inventory foreground application to a book checkout foreground application to checkout a book to a library patron, an indication that the foreground application is switching to the book checkout application can be received by the system 100. This indication can be passed to the switching component 120, which, in response, can switch the wedge component 110 to a book checkout data wedge configuration. When the library card is scanned by a bar code scanner, the patron's information can then properly populate the book checkout foreground application. Similarly, when each book's bar code is scanned, the book's information can properly populate the book checkout foreground application. After the checkout procedure is completed, when the employee switches back to the book inventory foreground application, an indication can be received by system 100 such that switching component 120 automatically switches the data wedge configuration profile to a book inventory configuration profile. This can allow scanned book bar codes to properly populate the book inventory foreground application.

The indication related to the foreground application can indicate changing from a first foreground application to a second foreground application, or changes within the first foreground application that would be amenable to changes in the data wedge configuration profile as herein discussed (e.g., switching from a first page to a second page in a spreadsheet foreground application, switching between fields in an item tracking foreground application, . . . ). Further, as herein discussed, where the indication related to the foreground application indicates switching to an unavailable data wedge configuration profile, a near match configuration profile or default configuration profile can be selected. Also, where a configuration profile is unavailable, an appropriate configuration profile can be defined rather than switching to a default or near match configuration profile.

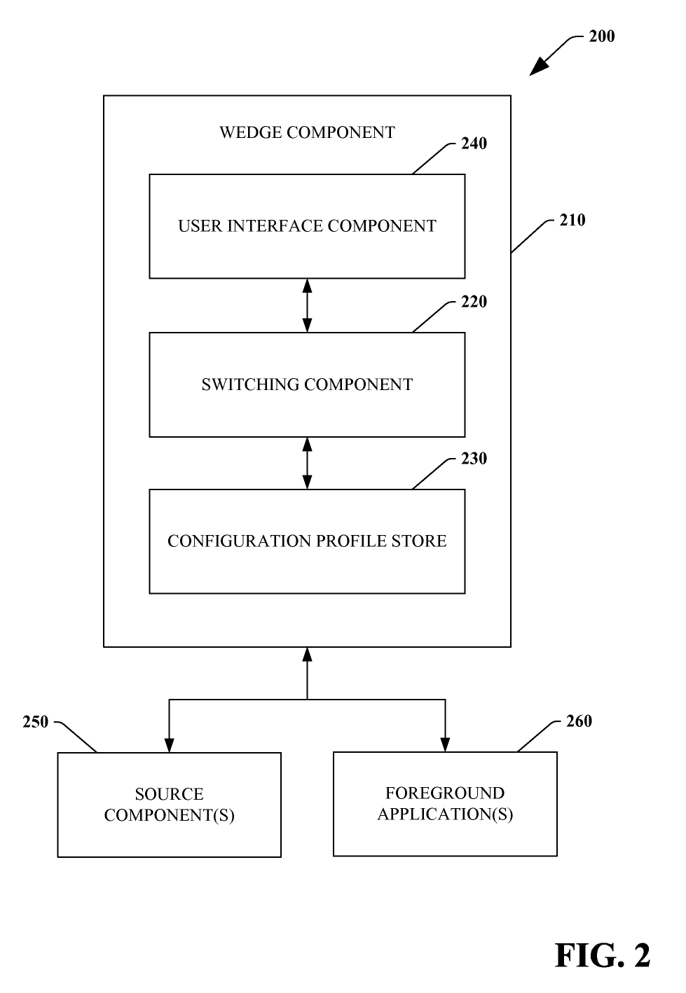

Referring now to FIG. 2, illustrated is a system 200 that can facilitate improved data wedge configuration switching in accordance with an aspect of the disclosed subject matter. System 200 can include wedge component 210 that can be the same as, or similar to, wedge component 110. Wedge component 210 can comprise a switching component 220, which can be the same as, or similar to, switching component 120, as herein discussed. Wedge component 210 can further comprise a configuration profile store (CPS) 230 that can store a plurality of data wedge configuration profiles. These profiles can be employed as herein discussed.

In an aspect, wedge component 210 can further include a user interface component 240. The user interface 240 can facilitate user interactions with the wedge component 210. These interactions can include, but are not limited to, selecting wedge settings, viewing wedge information, developing wedge configuration profiles, updating wedge configuration profiles, importing/exporting wedge configuration profiles, or combinations thereof, among other user interface activities.

Source component(s) 250, as herein discussed, can pass information to a foreground application 260 by way of wedge component 210 in system 200. Wedge component 210 can facilitate proper population of the foreground application 260 with the information from the source component(s) 250 based in part on a configuration profile. The switching component 220 can select an appropriate configuration profile, based in part on an indication relating to the foreground application 260, from the configuration profile store 230. Switching data wedge configuration profiles can be automated, based in part on inferences or determinations about the appropriateness of available configuration profiles. As will be appreciated by one of ordinary skill in the art, each component of system 200 can be located locally or distributed across a network while maintaining the described functionality.

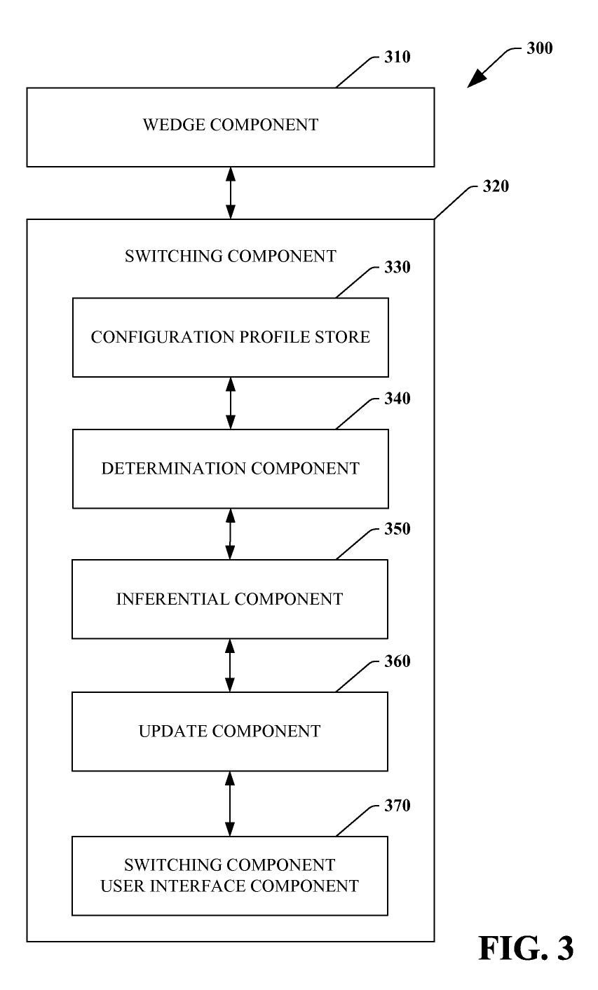

Referring now to FIG. 3, illustrated is a system 300 that can facilitate improved data wedge configuration switching in accordance with an aspect of the disclosed subject matter. System 300 can include wedge component 310 that can be the same as, or similar to, wedge component 210, 110. System 300 can further include a switching component 320 that can be the same as, or similar to, switching component 220, 120, as herein discussed. Switching component 320 can further include a configuration profile store, as herein discussed, that can be the same as, or similar to, configuration profile store 230.

Switching component 320 can further comprise a determination component 340 to facilitate determining the appropriateness of a configuration profile, based in part on an indication related to a foreground application, as discussed herein. The determination component 340 can cache the location of configuration profiles in the configuration profile store 330 to facilitate faster access to recently or regularly used configuration profiles. Further, the determination component 340 can base determinations on predetermined criteria for selecting an appropriate configuration profile. For example, the determination component 340 can receive an indication that the foreground application has switched to a version D spreadsheet application. The determination component 340 can then select a version C configuration profile where a version D configuration profile is unavailable and the predetermined criteria indicate that the version C configuration profile is an appropriate configuration profile for the version D spreadsheet application.

Switching component 320 can further comprise an inferential component 350 to facilitate determining the appropriateness of a configuration profile, based in part on an indication related to a foreground application, as discussed herein. The inferential component 350 can perform similarly to the determination component 340 except that determinations made by the inferential component 350 can be based on probability rather than more rigid predetermined criteria. Thus, from the example for the determination component 340 above, where a version D configuration profile is unavailable, and there is no predetermined criteria that version C is an appropriate configuration profile, the inferential component can form an inference that the version C configuration profile is acceptable where, for example, prior uses of the version C configuration profile with the version D foreground application have been manually selected by the user, a comparison of the fields of the version D and version C foreground application are similar, version C and version D are close in the development timeline of the software application (e.g., as compared to version 1.1. and version 10.2), or that no other spreadsheet configuration profile exists or is more closely related to the version D spreadsheet foreground application, among other considerations. One of skill in the art will appreciate that a nearly limitless number of considerations can be employed in forming an inference and that all such permutations are within the scope of the disclosed subject matter.

Where either the determination component 340 or the inferential component 350 determines that an appropriate configuration profile is unavailable, a default configuration profile can be selected. Similarly, a near match configuration profile can be selected rather than a default configuration profile. Additionally, the user can be presented with the option of developing a new configuration profile where the default or near match configuration profiles are inappropriate.

Switching component 320 can further comprise an update component 360 to facilitate updating of configuration profiles. Updating of configuration profiles can include updating currently running configuration profiles, updating saved configuration profiles, deleting saved configuration profiles, creating new configuration profiles, duplicating configuration profiles or parts thereof, importing configuration profiles or parts thereof, exporting configuration profiles or parts thereof, and viewing configuration profiles or parts thereof, or combinations thereof. The update component can provide differing levels of configuration profile access, for example, administrator and user levels, among many others. Switching component 320 can further comprise a switching component user interface component 370 to facilitate user interaction with the switching component 320. For example, the update component 360 can be accessed through the switching component user interface component 370 to update configuration profiles saved in the configuration profile store 330.

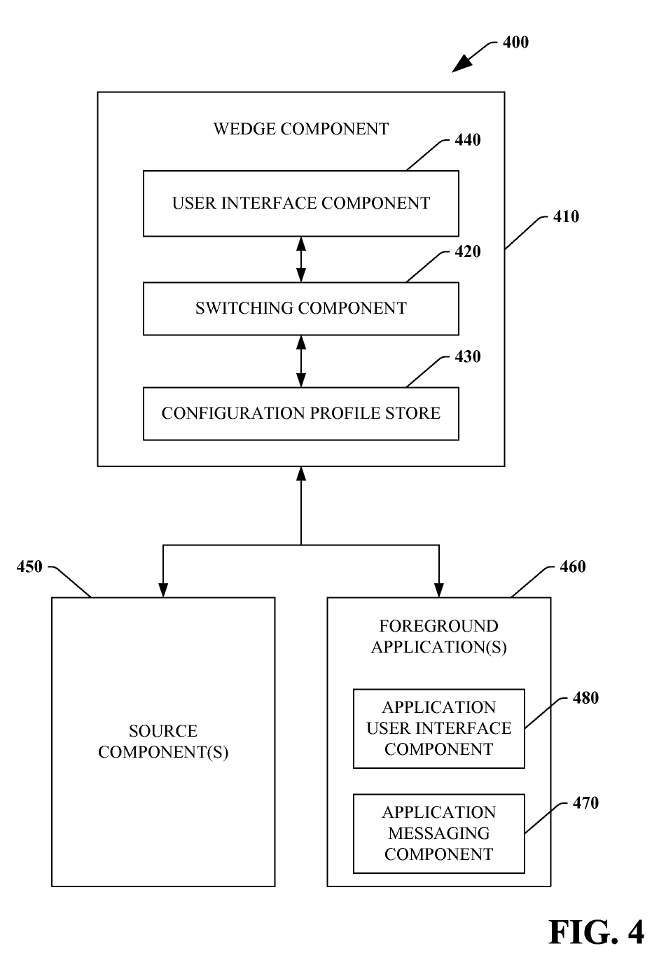

Referring now to FIG. 4, illustrated is a system 400 that can facilitate improved data wedge configuration switching in accordance with an aspect of the disclosed subject matter. System 400 can include wedge component 410 that can be the same as, or similar to, wedge component 310, 210, 110. The wedge component 410 can include a switching component 420 that can be the same as, or similar to, switching component 320, 220, 120. Further, the wedge component 410 can include a configuration profile store 430 that can be the same as, or similar to, configuration profile store 330, 230. The wedge component 410 can further include a user interface component 440 that can be the same as, or similar to, user interface component 240.

The wedge component 410 can be communicatively coupled (e.g., locally or in a distributed manner) to source component(s) 450 that can be the same as, or similar to, source component(s) 250. The source component(s) 450 can provide information for populating foreground applications(s) 460 that can be the same as, or similar to, foreground applications(s) 260, as herein discussed. Foreground application(s) 460 can include an application user interface component (AUIC) 480 and an application messaging component 470.

The AUIC 480 can facilitate user interactions with the foreground application. The AUIC 480 can provide a means for directing the placement of information from the source component(s) 450 by way of the wedge component 410 for populating the foreground application(s) 460. Further, the application messaging component 470 can provide messages that can function as indications relating to the foreground application to the wedge component 410 or other system components. As herein discussed, the message (e.g., an indication related to a foreground application) can be leveraged to initiate automatic data wedge configuration profile switching where the foreground application entry scheme changes. For example, where the foreground application 460 is a spreadsheet application with different entry scheme for each page in the spreadsheet application, as the user changes pages within the spreadsheet application, the application messaging component 470 can send messages to the wedge component 410 to initiate an automatic data wedge configuration profile change for each spreadsheet page transition. Thus, as the user, for example, switches from an item tracking spreadsheet page to a customer information spreadsheet page, the wedge component can be messaged (e.g., by the application messaging component 470) such that the switching component 420 of the wedge component 410 can automatically switch the data wedge configuration profile from an item tracking configuration profile to a customer information configuration profile. As discussed herein, available configuration profiles can be stored in the configuration profile store 430.

Further, where a matching configuration profile is unavailable, a near match configuration profile or default configuration profile can be selected by the switching component 420 (e.g., a deterministic or inferential determination can be made by the switching component 420 to select a near match or default configuration profile). Also as herein discussed, a user can create a new configuration profile where an appropriate configuration profile is unavailable and switching to a near match or default configuration profile s undesirable, this can be facilitated by the AUIC 480.

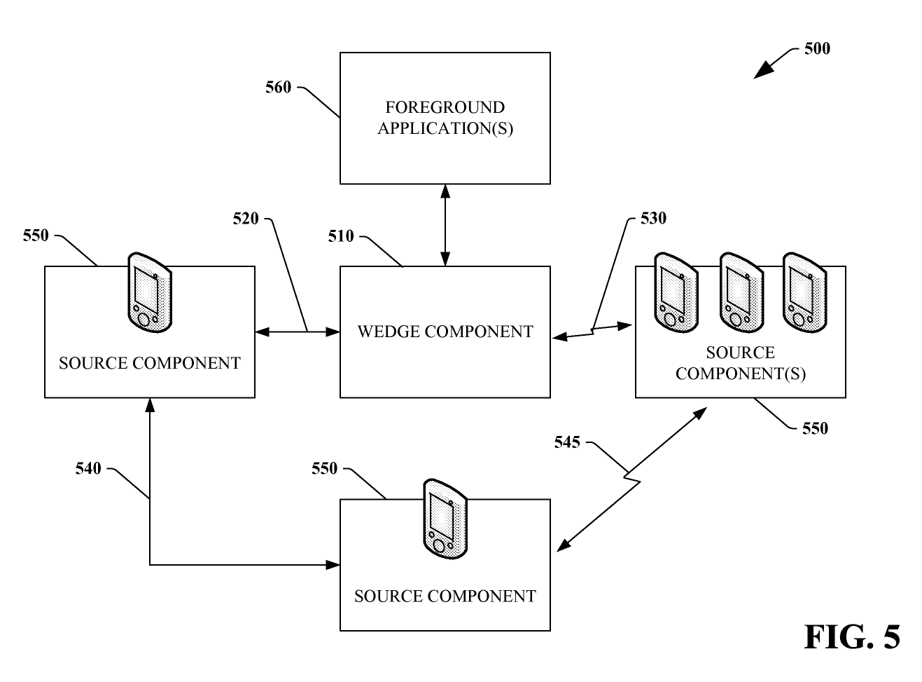

Referring now to FIG. 5, a schematic illustration of a system that can facilitate improved data wedge configuration switching in accordance with an aspect of the subject matter disclosed herein. The system 500 can include a wedge component 510, that can be the same as, or similar to, wedge component 110, 210, 310, 410. The wedge component 510 can facilitate automatic switching of data wedge configuration profiles as herein discussed. This automatic switching can increase productivity by freeing the user from manually switching data wedge configuration profiles. Similarly, automatic configuration profile switching can reduce errors associated with improper manual configuration profile switching (e.g., failure to switch configuration profiles, switching to an inappropriate configuration profile, . . . ).

System 500 can support wired communications 520, wireless communications 530, or combinations thereof, for communicatively coupling system 500 components with the wedge component 510. Further, system 500 can support wired network connections 540 (e.g., daisy chains, system busses, intranets, wide area networks (WANs), local area networks (LANs), . . . ), wireless network connections 545 (e.g., daisy chains, system busses, intranets, wide area networks (WANs), local area networks (LANs), . . . ), or combinations thereof for communicatively coupling system 500 components with the wedge component 510. For example, source component(s) 550 can be communicatively coupled through a wired connection (e.g., 520), a wireless connection (e.g., 530), a wired daisy chained (e.g., 540), a wireless LAN (e.g., 545), or combinations thereof to the wedge component 510. Similarly, the wedge component 510 can be communicatively coupled through a wired or wireless connection to the foreground application(s) 560. One of skill in the art will appreciate that these wired or wireless connections 520, 530, 540, 545, can facilitate local connections or connections distributed across a network, such as an enterprise WAN, a corporate LAN, or the internet, among other examples.

While the source component(s) 550 are illustrated as devices, one of skill in the art will appreciate that the source component(s) 550 are not so limited. The source component(s) 550 can include devices, systems, and/or methods that facilitate the presentation of information to a foreground application. Typical data wedge systems and devices sit between a source component 550 and a foreground application 560 to facilitate proper population of the foreground application with the information presented by the source component(s) 550. Thus, source component(s) 550 can range from the very simple to the highly complex, for example, from a simple numeric key pad to a highly complex data base system presenting information to a foreground application based on laser scanning of barcodes, among numerous other examples.

By allowing the wedge component to be located either locally or in a distributed manner, across wireless and wired communicative couplings, the wedge component can facilitate automatic configuration profile switching in a broad range of data wedge applications. For example, where a source component 550 is a simple numeric key pad, the wedge component can be locally wired between the key pad and a CPU running the foreground application to facilitate automatic configuration profile switching. Similarly, for example, where the source component(s) 550 are a highly integrated device having laser scanning, numeric key pad entry, alpha key pad entry, and radio frequency identification (RFID) scanning, coupled to a lookup database running on a remote corporate server, the wedge component 510 can be, for example, similarly remotely located and still provide automatic configuration profile switching for the foreground application (e.g., even where the foreground application is running on the same source component(s) 550).

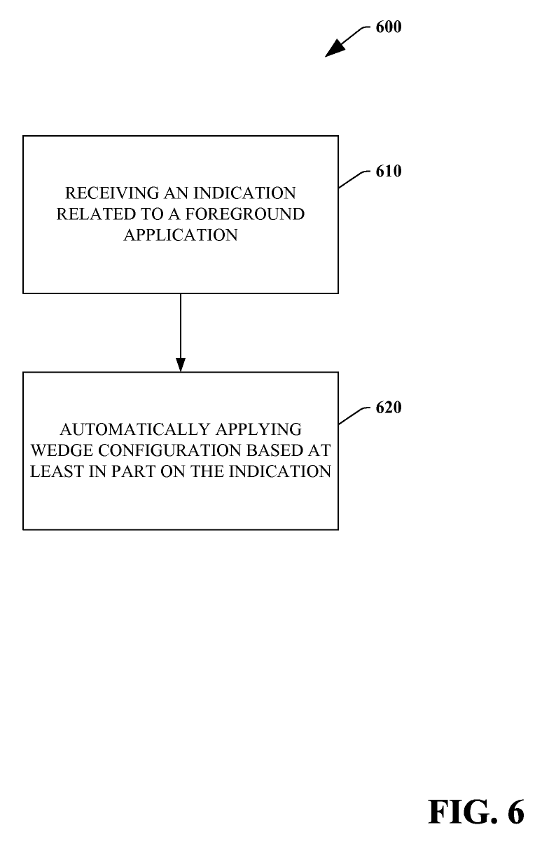

FIGS. 6-9 illustrate methodologies, flow diagrams, and/or timing diagrams in accordance with the disclosed subject matter. It is to be appreciated that the methodologies presented herein can incorporate actions pertaining to a neural network, an expert system, a fuzzy logic system, and/or a data fusion component, or a combination of these, which can generate diagnostics indicative of the optimization of an automatic data wedge configuration profile switching system germane to the disclosed methodologies. Further, the prognostic analysis of this data can serve to optimize an automatic data wedge configuration profile switching system, and can be based on real time acquired data or historical data within a methodology or from components related to a methodology herein disclosed, among others. It is to be appreciated that the subject invention can employ highly sophisticated diagnostic and prognostic data gathering, generation and analysis techniques, and such should not be confused with trivial techniques (e.g., simply associating a profile switch with a foreground application startup button).

For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 6, illustrated is a methodology 600 that facilitates improved data wedge configuration switching in accordance with an aspect of the subject matter disclosed herein. Conventional methodologies generally employ manual user initiation of configuration profile switching to change configuration profiles for a data wedge in relation to changing foreground applications or foreground application information input schema. These methodologies can be subject to errors (e.g., the user selects an inappropriate configuration profile, the user fails to change the configuration profile, . . . ) and can result in lowered productivity (e.g., the user spends time manually changing the configuration profile, the user has to search for the most appropriate configuration profile, . . . ).

The methodology 600 can facilitate automatic configuration profile switching for data wedges. At 610, methodology 600 can receive an indication related to a foreground application. The received indication can indicate, for example, that the foreground application has changed to a different foreground application, that the information input scheme for a foreground application has changed, that a message has been received from a foreground application indicating that a different configuration profile is appropriate, or combinations thereof, among other indications related to a foreground application.

At 620, methodology 600 can automatically apply a data wedge configuration based at least in part on the received indication. The configuration profile can be selected from a plurality of configuration profiles stored in a configuration profile store, such as the configuration profile store 230, 330, 430. Selecting an appropriate configuration profile can be in response to receiving an indication related to the foreground application, as discussed herein. For example, where an indication is received that relates to the foreground application changing from a first to a second application, at 620, the wedge configuration can be automatically switched to a configuration profile appropriate for the second foreground application by automatically applying a wedge configuration selected from a plurality of configuration profiles. As a second example, where an indication is received that relates to the foreground application changing from a first to a second information entry scheme (e.g., different pages, forms, . . . ) in a foreground application, at 620, the wedge configuration can be automatically switched to a configuration profile appropriate for the second information entry scheme for the foreground application by automatically applying a wedge configuration selected from a plurality of configuration profiles. At this point, methodology 600 can end.

In an aspect, configuration profiles can be created for a plurality of foreground applications or a plurality of information entry schemes within any foreground application. In contrast to conventional data wedge methods that can remain ignorant of the foreground application environment, the data wedge methods disclosed herein can automatically change the configuration profile to a match, near match, default, or custom configuration profile to improve productivity and reduce errors. At 610, the received indication can be generated by the foreground application, an operating system, an application program interface (API), can be sensed by monitoring the operation of the system upon which the foreground application is running, or combinations thereof. Based at least in part on this indication, the data wedge, as herein described, can determine or infer the appropriate configuration profile to select. The selected data wedge configuration can be applied to the data wedge by a switching component (e.g., 120, 220, 320, 420) to allow the data wedge to appropriately populate the foreground application with information from a source component (e.g., 250, 450).

Wherein methodology 600 can employ inferences as herein described for selecting an appropriate configuration profile, the inference can be based on factors such as recently selected configuration profiles, user updated configuration profiles, foreground application software versions, source component identities, anticipated foreground application changes, or combinations thereof among a nearly limitless number of other factors. For example, inferences can be determined that a user typically switches to a product shipping application after populating a product purchase foreground application. Based on this inference, there can be an associated probability that the user will again select the wedge configuration profile for product shipping after the user has entered a product sale in the product purchase foreground application. Based at least in part on this inference, the data wedge as herein described can select the product shipping configuration profile when the user switches from the product purchase application. As will be appreciated by one of skill in the art, the use of inferences can add substantial benefit to determining an appropriate configuration profile for automatic data wedge configuration profile switching.

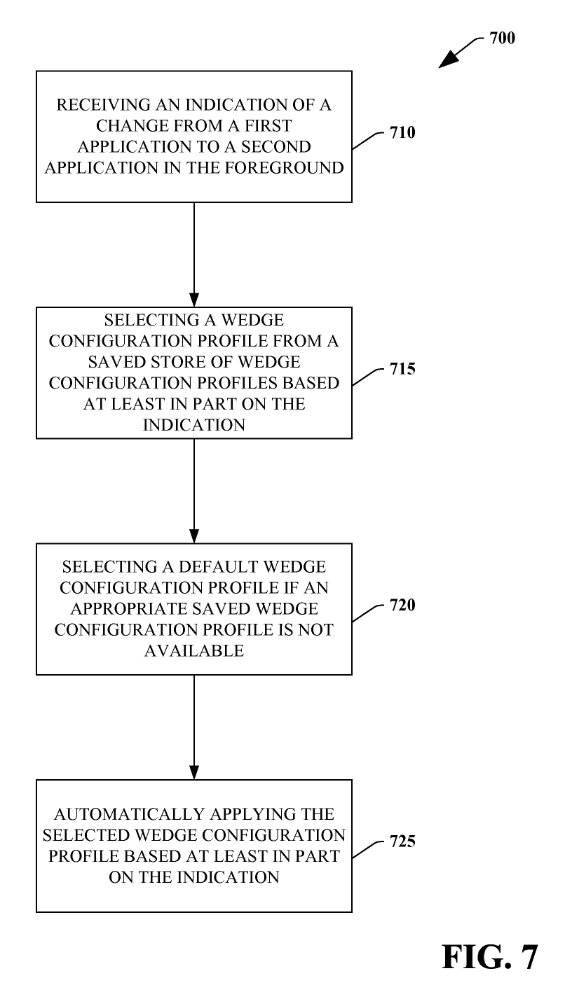

Referring now to FIG. 7, illustrated is a methodology 700 that facilitates improved data wedge configuration switching in accordance with an aspect of the subject matter disclosed herein. At 710, methodology 700 can receive an indication of a change from a first foreground application to a second foreground application. The indication can be the same as, or substantially similar to, the indication as discussed at length herein. At 715, a wedge configuration profile can be selected from a plurality of stored wedge configuration profiles based at least in part on the indication receive at 710. As discussed herein, the selection can be based on predetermined criteria or can be inference based. At 720, where an appropriate configuration profile is unavailable, a default wedge configuration profile can be selected.

Additionally, where a near match configuration profile is available, the method 700 can select the near match as the default configuration profile. As discussed herein, the user can also be prompted to create a new configuration profile as the default behavior when a matching (or near matching) configuration profile is unavailable. These alternatives are not illustrated in the method to keep the illustration of the method more clear.

At 725, the selected configuration profile can be automatically applied to the data wedge. Where the selected configuration profile is automatically applied, the user can generally be relieved of needing to manually initiate a data wedge configuration profile change in addition to changing the foreground application (or the information input scheme of the foreground application, see methodology 800). This can result in improved productivity and reduced errors. After this, method 700 can end.

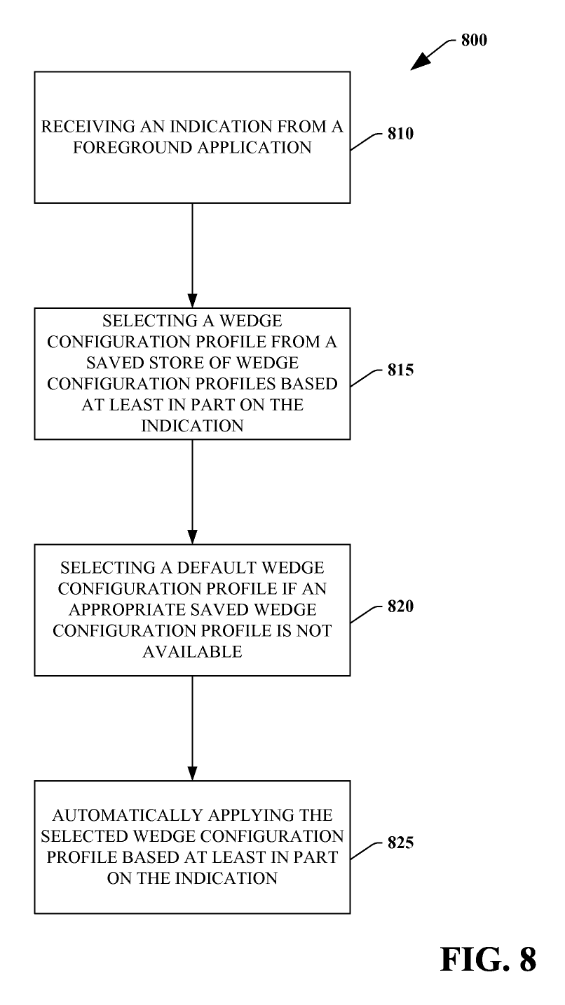

Referring now to FIG. 8, illustrated is a methodology 800 that facilitates improved data wedge configuration switching in accordance with an aspect of the subject matter disclosed herein. At 810, methodology 800 can receive an indication of a change in a first foreground application from a first information input scheme to a second information input scheme. The indication can be the same as, or substantially similar to, the indication as discussed at length herein. At 815, a wedge configuration profile can be selected from a plurality of stored wedge configuration profiles based at least in part on the indication receive at 810. As discussed herein, the selection can be based on predetermined criteria or can be inference based. At 820, where an appropriate configuration profile is unavailable, a default wedge configuration profile can be selected.

Additionally, where a near match configuration profile is available, the method 800 can select the near match as the default configuration profile. As discussed herein, the user can also be prompted to create a new configuration profile as the default behavior when a matching (or near matching) configuration profile is unavailable. These alternatives are not illustrated in the method to keep the illustration of the method more clear.

At 825, the selected configuration profile can be automatically applied to the data wedge. Where the selected configuration profile is automatically applied, the user can generally be relieved of needing to manually initiate a data wedge configuration profile change in addition to changing the information input scheme of the foreground application (or the foreground application, see methodology 700). This can result in improved productivity and reduced errors. After this, method 800 can end.

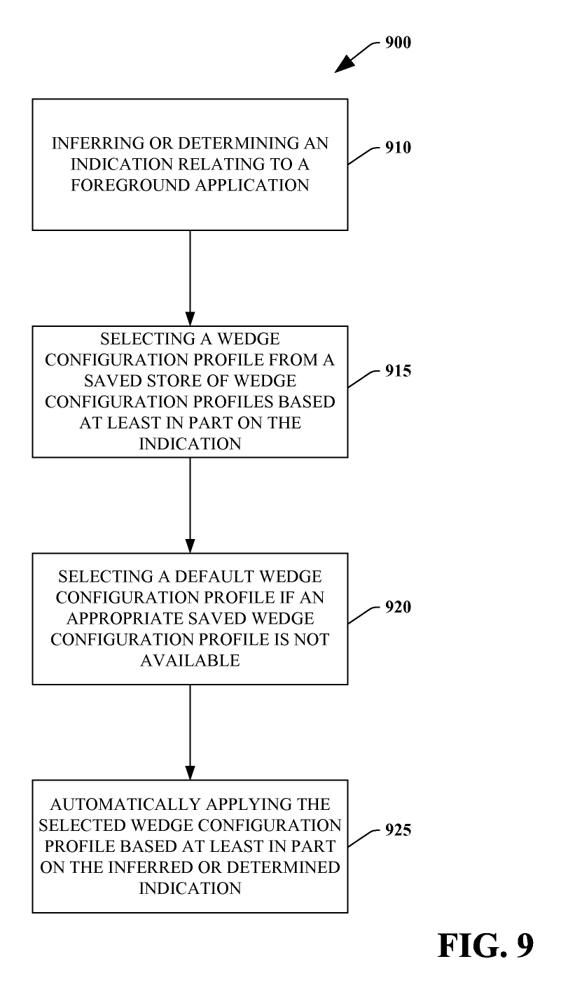

Referring now to FIG. 9, illustrated is a methodology 900 that facilitates improved data wedge configuration switching in accordance with an aspect of the subject matter disclosed herein. At 910, an indication relating to a foreground application can be inferred. Where sufficient information is available, inferences can provide highly accurate predictions of expected behaviors. An inference about an indication related to a foreground application can be based, for example, on historical user behaviors, such as, many corporate environments have a flow of work defined that includes switching through a preselected order of foreground applications or changes in information input schemes during a typical work flow.

An example of this behavior can be where a pharmacist provides a medication to a customer, wherein the work flow includes, for example, a customer entry scheme (A), a drug inventory scheme (B), a pricing foreground application (C), and a sales foreground application (D). Thus, for each customer the pharmacist assists, they repeatedly cycle through data wedge configuration profiles A-D. Based on this predictable behavior, an inference can be formed that when the pharmacist switches from customer entry, they are likely to switch to drug inventory, and when they switch from drug inventory, they are likely to switch to drug pricing, and so on. Thus, based at least in part on this inference, a switching component can infer appropriate configuration profiles for the automatic data wedge configuration profile switching behavior. Where the work flow is entered by the pharmacist, a switching component (e.g., 120, 220, 320, and 420) can not only form an inference about the individual configuration profile changes but can form inferences about the configuration profile changes for the entire workflow. This can allow additional benefits, for example, pre-fetching of likely configuration profiles. These simple examples are only intended to illustrate that inferences can be determined and that by combining simple inferences, more complex inferences can be made.

Inferences can also be formed based on numerous other factors, including performance analysis, business goals, user specific behaviors, user profiles, foreground application software version, or combinations thereof among a nearly limitless number of other factors. One of skill in the art will appreciate that all such factors are considered within the scope of the disclosed subject matter.

At 915, a wedge configuration profile can be selected from a plurality of stored wedge configuration profiles, as discussed herein, based at least in part on the inferred indication relating to a foreground application at 910. At 920, where an appropriate configuration profile is unavailable, a default wedge configuration profile can be selected. Additionally, where a near match configuration profile is available, the method 900 can select the near match as the default configuration profile. As discussed herein, the user can also be prompted to create a new configuration profile as the default behavior when a matching (or near matching) configuration profile is unavailable. These alternatives are not illustrated in the method to keep the illustration of the method more clear.

At 925, the selected configuration profile can be automatically applied to the data wedge. Where the selected configuration profile is automatically applied, the user can generally be relieved of needing to manually initiate a data wedge configuration profile change in addition to changing the information input scheme of the foreground application or the foreground application. This can result in improved productivity and reduced errors. After this, method 900 can end.

It is to be appreciated that more complex inferential determinations can be made regarding indications relating to a foreground application or what constitutes an appropriate match or near match configuration profile, as discussed herein. It is to be further appreciated that further inferences and determinations can be based at least in part on determinations about changes in the foreground application, changes in the information input scheme of a foreground application, available configuration profiles, user historical behaviors, work flows, software/hardware upgrades, source components, and the like, as also discussed herein. All such modifications of method 900 are considered to be within the scope of the disclosed subject matter.

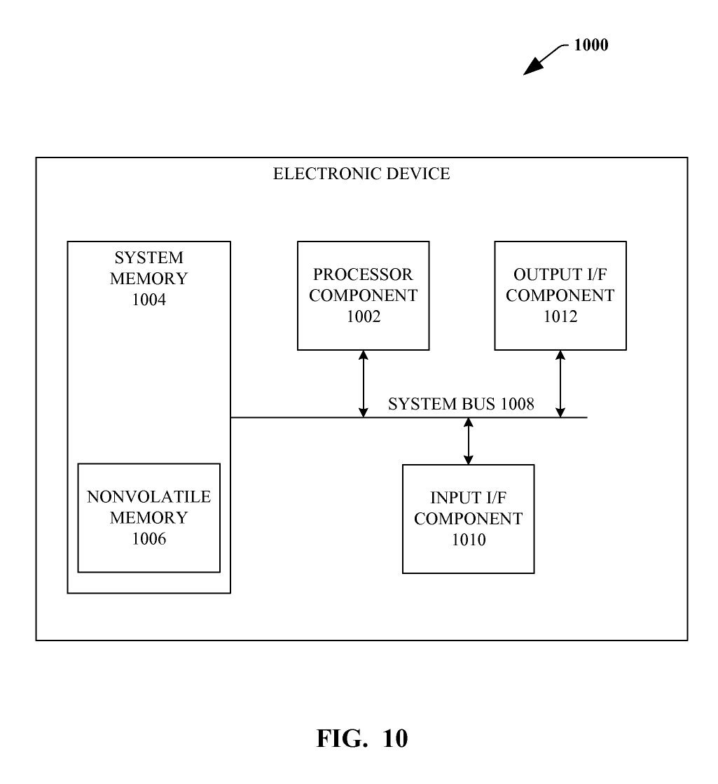

Referring to FIG. 10, illustrated is a block diagram of an exemplary, non-limiting electronic device 1000 that can facilitate automatic data wedge configuration profile switching in accordance with one aspect of the disclosed subject matter. The electronic device 1000 can include, but is not limited to, a computer, a laptop computer, barcode scanners, optical scanners, network equipment (e.g. routers, access points), a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system (e.g., global position satellite (GPS) system), secure memory devices with computational capabilities, devices with tamper-resistant chips, an electronic device associated with an industrial control system, an embedded computer in a machine (e.g., an airplane, a copier, a motor vehicle, a microwave oven), and the like.

Components of the electronic device 1000 can include, but are not limited to, a processor component 1002, a system memory 1004 (with nonvolatile memory 1006), and a system bus 1008 that can couple various system components including the system memory 1004 to the processor component 1002. The system bus 1008 can be any of various types of bus structures including a memory bus or memory controller, a peripheral bus, or a local bus using any of a variety of bus architectures.

Electronic device 1000 can typically include a variety of computer readable media. Computer readable media can be any available media that can be accessed by the electronic device 1000. By way of example, and not limitation, computer readable media can comprise computer storage media and communication media. Computer storage media can include volatile, non-volatile, removable, and non-removable media that can be implemented in any method or technology for storage of information, such as computer readable instructions, data structures, program modules or other data. Computer storage media includes, but is not limited to, RAM, ROM, EEPROM, nonvolatile memory 1006 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 1000. Communication media typically can embody computer readable instructions, data structures, program modules or other data in a modulated data signal such as a carrier wave or other transport mechanism and includes any information delivery media.

The system memory 1004 can include computer storage media in the form of volatile and/or nonvolatile memory 1006. A basic input/output system (BIOS), containing the basic routines that help to transfer information between elements within electronic device 1000, such as during start-up, can be stored in memory 1004. Memory 1004 can typically contain data and/or program modules that can be immediately accessible to and/or presently be operated on by processor component 1002. By way of example, and not limitation, system memory 1004 can also include an operating system, application programs, other program modules, and program data.

The nonvolatile memory 1006 can be removable or non-removable. For example, the nonvolatile memory 1006 can be in the form of a removable memory card or a USB flash drive. In accordance with one aspect, the nonvolatile memory 1006 can include flash memory (e.g., single-bit flash memory, multi-bit flash memory), ROM, PROM, EPROM, EEPROM, or NVRAM (e.g., FeRAM), or a combination thereof, for example. Further, the flash memory can be comprised of NOR flash memory and/or NAND flash memory.

A user can enter commands and information into the electronic device 1000 through input devices (not shown) such as a keypad, function buttons, trigger, microphone, graphical user interface, tablet or touch screen although other input devices can also be utilized. These and other input devices can be connected to the processor component 1002 through input interface component 1012 that can be connected to the system bus 1008. Other interface and bus structures, such as a parallel port, game port or a universal serial bus (USB) can also be utilized. A graphics subsystem (not shown) can also be connected to the system bus 1008. A display device (not shown) can be also connected to the system bus 1008 via an interface, such as output interface component 1012, which can in turn communicate with video memory. In addition to a display, the electronic device 1000 can also include other peripheral output devices such as speakers (not shown), which can be connected through output interface component 1012.

It is to be understood and appreciated that the computer-implemented programs and software can be implemented within a standard computer architecture. While some aspects of the disclosure have been described above in the general context of computer-executable instructions that may run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

As utilized herein, terms “component,” “system,” “interface,” and the like, can refer to a computer-related entity, either hardware, software (e.g., in execution), and/or firmware. For example, a component can be, but is not limited to being, a process running on a processor, a processor, a circuit, a collection of circuits, an object, an executable, a thread of execution, a program, and/or a computer. By way of illustration, both an application running on a server and the server can be a component. One or more components can reside within a process and a component can be localized on one computer and/or distributed between two or more computers.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the disclosed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

### Artificial Intelligence

Artificial intelligence based systems (e.g., explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

For example, an artificial intelligence based system can evaluate current or historical evidence associated with data access patterns (e.g., configuration profiles recently employed, user specific historical evidence, configuration profile updates, new configuration profiles, or combinations thereof, among others, . . . ) and based in part in such evaluation, can render an inference, based in part on probability, regarding, for instance, that a select order of configuration profile changes will occur based on entering a work flow at a known point, among many others. One of skill in the art will appreciate that intelligent and/or inferential systems can facilitate further optimization of the disclosed subject matter and such inferences can be based on a large plurality of data and variables all of with are considered within the scope of the subject innovation.

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates automatic data wedge configuration profile switching comprising:
a data wedge component; and
a switching component communicatively coupled to the data wedge component, wherein the switching component automatically switches a configuration profile of the data wedge component.

2. The system of claim 1, further comprising a configuration profile store.

3. The system of claim 2, wherein at least one configuration profile is stored on the configuration profile store.

4. The system of claim 3, wherein an indication related to a foreground application is received.

5. The system of claim 4, wherein the indication related to a foreground application relates to a change from a first to a second foreground application, relates to an information input scheme change within a foreground application, relates to a message sent from a foreground application, or some combination thereof.

6. The system of claim 5, wherein the switching component selects a most appropriate data wedge configuration profile from the at least one configuration profile stored.

7. The system of claim 6, wherein the most appropriate data wedge configuration profile selected is a configuration profile matching the foreground application.

8. The system of claim 6, wherein the most appropriate data wedge configuration profile selected is a default data wedge configuration profile.

9. The system of claim 6, wherein the most appropriate data wedge configuration profile selected is a near match data wedge configuration profile.

10. The system of claim 1, wherein a configuration profile can be created, edited, stored, loaded, accessed, imported, exported, shared, or some combination thereof, either in whole or in part.

11. The system of claim 1, further comprising an inferential component, wherein the inferential component can form an inference related to an appropriate data wedge configuration profile to facilitate automatic data wedge configuration profile switching.

12. An electronic device comprising the system of claim 1.

13. A method that facilitates automatic data wedge configuration profile switching comprising:
receiving an indication related to a foreground application; and
automatically applying a data wedge configuration profile, based at least in part on the indication received.

14. The method of claim 13, wherein the indication received is related to a change from a first foreground application to a second foreground application.

15. The method of claim 13, wherein the indication received is related to a change from a first information input scheme to a second information input scheme in the foreground application.

16. The method of claim 13, further comprising selecting a most appropriate data wedge configuration profile to automatically apply.

17. The method of claim 16, wherein the most appropriate data wedge configuration profile is a default data wedge configuration profile.

18. The method of claim 16, wherein the most appropriate data wedge configuration profile is a data wedge configuration profile matching the foreground application.

19. The method of claim 16, wherein the most appropriate data wedge configuration profile is a near match data wedge configuration profile.

20. The method of claim 13, wherein the indication can inferred based at least in part on determinations, inferences, or combinations thereof, relating to historical configuration profile switches, historical work flows, user profiles, foreground application software versions, or combinations thereof.
